(19) United States
(12) Patent Application Publication
(10) Pub. No.: US 2003/0173270 A1
(43) Pub. Date: Sep. 18, 2003

(54) Device for transporting and sorting unit loads

(75) Inventors: Dominik Graefer, Nurnberg (DE); Michele Vitalini, Nurnberg (DE)

Correspondence Address: SIEMENS SCHWEIZ, I-44, INTELLECTUAL PROPERTY, ALBISRIEDERSTRASSE 245, ZURICH, CH-8047, CH

(73) Assignee: SIEMENS SCHWEIZ AG, Zurich (CH)

(21) Appl. No.: 10/414,470

(22) Filed: Apr. 16, 2003

Related U.S. Application Data
(63) Continuation of application No. PCT/EP01/10803, filed on Sep. 19, 2001.

(30) Foreign Application Priority Data
Oct. 16, 2000 (EP) 00122526.7
Nov. 16, 2000 (EP) 00125657.7

(51) Int. Cl. B07C 9/00; B07C 5/12

(52) U.S. Cl. 209/663; 209/655

(57) ABSTRACT

The present invention relates to a sorting unit for conveying items in a first direction, while, by using the same driving force, the unit may be selectively displaced in a second direction. The first and second directions may be transversal, with the first direction being facilitated by a conveyor or endless belt. The sorting unit may be part of a sorting line where consideration must be given for conveying items in one or more directions. In the present sorting unit, a track is introduced into a driving cylinder. Appropriately placed guide members selectively engage the track. The guide members may be fixed with respect to the second direction. The cylinder may be used to drive the above belt. Therefore, when the members engage the track, and accordingly the cylinder, the rotational force of the cylinder causes the sorting unit, via the guide members to displace in the second direction.

### BACKGROUND OF THE INVENTION

The invention relates to a device for transporting and sorting unit loads, in which at least one feed station and/or at least one discharge station is located along a sorting line and in which a transport device is guided and driven and equipped with successive sorting units and in which each sorting unit has a belt band which can be driven perpendicular to the sorting line.

Devices for transporting and sorting unit loads with a transport device guided along a sorting line and these sorting units located one behind the other and moving transversely to the direction of transport are already generally known. The unit load to be transported can be moved by a feed device at an angle in the sorting line and onto a passing sorting unit. The belt band fitted on the sorting unit is then moved in the same direction as the band of the feed device in the unit load transfer area. During discharge into a chute and/or a transfer point, the belt band of the sorting unit is moved transversely to the sorting line towards the end point.

A distinction is currently made between two different drive mechanisms for the belt band drive of the sorting unit. These are electromechanical and mechanical drive mechanisms.

In the case of electromechanical drive mechanisms, energy can be transferred in contactless fashion by induction or by means of mechanical elements such as sliders and collector wires. In the case of mechanical drive mechanisms, the linear movement of the transport device is converted into a rotational movement of the belt band of the sorting unit.

The above last-mentioned sorting unit with a mechanical drive mechanism is disclosed in European patent application EP 0 930 248 A2.

The optional drive of the belt bands of the sorting units in the discharge stations is achieved by frictional connection between two drive systems. The first drive systems are located in each instance in the area of the discharge station and these can be made to interact with the second drive systems located on the sorting units as a sorting unit passes. The second drive systems of the sorting units include at least one frictional wheel connected for drive purposes to the belt band of the relevant sorting unit. The first drive systems, which are assigned to the discharge stations of the sorting line, are frictional strips extending in the direction of transport which can optionally be made to interact with frictional connection with the frictional wheels of the sorting units. These each make contact, in the discharge station in which a unit load transferred to a sorting unit is to be discharged, with the frictional wheel of the sorting unit, in this way driving the frictional wheel in rotational fashion as the discharge station passes. In this way the rotational movement of the frictional wheel is transferred to the belt band. Enough energy must be supplied to overcome mass inertia during acceleration of the unit load. Contact between the first and second drive elements therefore operates with a high level of expenditure of force.

The previously known sorting unit has been proven with regard to low cost and simple structure but appears to need improvement in respect of the following points:

a) unwanted conversion of mechanical energy into heat energy, which has a negative effect on the material characteristics of the twin drive system;

b) resulting wear of frictional wheels and frictional strips;

c) high level of stress and wear affecting the other mechanical components due to the very high level of expenditure of force to generate the frictional connection;

d) a constantly decreasing friction coefficient due to dirt, environmental factors and wearing particles; and

e) very heavy unit loads cannot be reliably accelerated and/or definitively slowed down and moved to the discharge station, as the maximum possible friction forces of the twin drive system are limited to overcome mass inertia moments. The acceleration and/or slowing response of unit loads cannot therefore be calculated in a controlled fashion.

### SUMMARY OF THE INVENTION

An advantage of the present invention is to improve the mechanical drive mechanism of the belt band of the sorting unit on the basis of the above and equally to seek to achieve a lower-energy, low-wear drive mechanism and the defined movement of a greater unit load weight.

This and other advantages is achieved according to the invention, with a device for transporting and sorting unit loads of the type mentioned above, by utilizing a positive fit deflection of the translatory linear movement of the transport unit into a rotational movement for the optional drive of the belt bands of the sorting units in the discharge stations.

In an embodiment of the present invention a rotatable cylinder is used with at least one spiral guide track and at least one guide element which can be engaged with the guide track to generate the positive fit deflection. The guide track can be configured as a groove in the surface of the cylinder or as a guide track projecting from the surface of the cylinder. If the guide track is configured as a groove in the surface of the cylinder, at least one guide element engages with the guide track. The guide element is configured as pin-like. The pin-like guide element has activation rollers preferably on bearings. It can therefore be moved along the guide track with little friction.

If a right/left movement of the belt band is intended, in a further embodiment the cylinder has at least two spiral guide tracks in opposite directions, which cross at least at two points. In order to be able to guide the guide element precisely at the crossing points of the spirally opposing guide tracks, the configuration of the at least one pin-like guide element as a twin element is extremely advantageous.

This twin element ensures that the cylinder is not without guidance in the area of the crossing points of two guide tracks. A further structural option to ensure precise guidance of the guide elements at the crossing points of the guide tracks is to configure the guide tracks with different depths and widths so that the use of a twin element is no longer essential.

For the accurate and quiet insertion of the at least one guide element into the guide track of the cylinder, an insertion aid is provided at the beginning of the guide track.

The cylinder is moved along on the sorting unit. The at least one guide element is located at a relatively fixed point with respect to this. An optional right/left movement of the belt band of the sorting unit is achieved by mounting at least one guide element on the left and/or right side of the transport device so that it is stationary in relation to the direction of travel of the transport device and engaging it with and/or disengaging it from the guide track on the basis of a control signal.

The cylinder is positioned in rotatable fashion on a support tube, which is connected to the travel gear of the transport device. The rotational movement of the cylinder is transferred by means of belts to the guide cylinder of the belt band.

To ensure that the cylinder returns to its initial position after at least one rotation and subsequent drive elements can engage precisely with the guide track, the guide track is configured structurally so that it has a smaller gradient at its beginning and/or at its end than in its central area, so that the gradient pattern is continuous.

The appropriate advance of the belt band for the sorting unit application can be adjusted using the dimensions of the diameter of the belt pulleys.

The dimensions of the diameters of the first and second belt pulleys are such that a rotational movement of the cylinder once about its own axis produces an advance of the belt band corresponding to the sorting unit application.

In addition to the dimensions of the belt pulleys, the number of guide tracks around the cylinder can be varied. With a guide track which goes round the cylinder more than once, the axial length of the cylinder and therefore the width of the belt band can be reduced for the same belt band advance. This allows the sorting unit to be configured in various sizes. The axial length of the cylinder is therefore determined by a whole-number multiplication of the guide track 360° around the cylinder, to ensure the necessary advance of the belt band for the relevant application.

The cylinder can however also be configured in a further embodiment with one guide track, which is split into a number of guide track segments one behind the other. In this embodiment a number of guide elements are engaged, making the cylinder rotate gradually. This rotation of the cylinder can be accelerated, operated at constant speed or slowed down according to the curvature of the guide track segments. This produces different movement profiles for the belt band advance. The movement of the belt band can for example be divided into three different movement processes. In the first part of the belt band movement the belt band is accelerated, in the second part it is moved at constant speed and in the third part it is slowed down. In addition to the shorter length of the cylinder, different speed profiles can be produced for the belt band in this embodiment. This ensures precise collection and delivery of the unit loads at the collection stations.

With the above embodiments it is possible to drive the belt band of the sorting unit with less energy expenditure with controlled acceleration and/or at uniform speed and/or with controlled slowing. At the same time wear on the mechanical components is reduced resulting in a longer sorting unit life.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts a device according to the present invention as viewed from below;

FIG. 2 depicts guide pins engaged in guide tracks of the width and depth;

FIG. 3 depicts a grooved cylinder in an embodiment with two guide tracks of different width and depth;

FIG. 4 depicts an alternative configuration of the guide track of the grooved cylinder in different guide track segments; and

FIG. 5 depicts different variations of the guide track of the grooved cylinder.

### DETAILED DESCRIPTION OF THE INVENTION

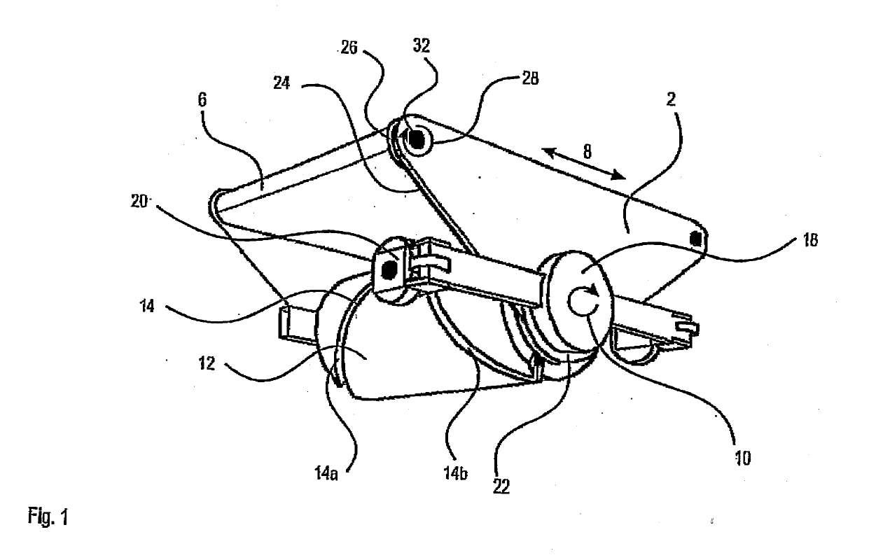

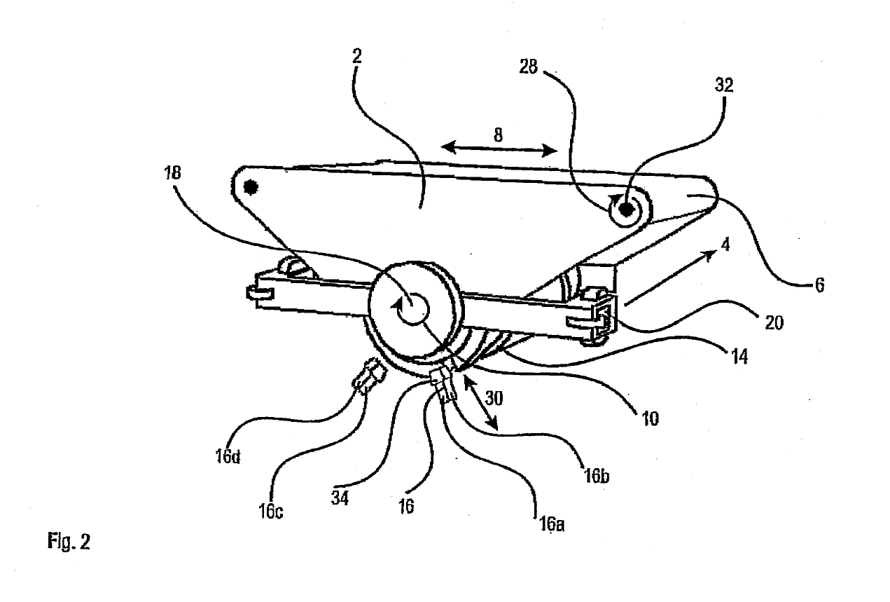

FIG. 1 shows a diagram of a sorting unit 2 of a transport device shown from below. The sorting unit 2 is connected to other sorting units in a transport device in a closed chain. The sorting units 2 are moved by a drive mechanism not shown here in the direction of transport 4 (FIG. 2). This movement in the direction of transport 4 is used for the optional drive of a belt band 6 of the sorting unit 2. A movement 8 of the belt hand 6 of the sorting unit 2 moves transversely to the direction of transport of the sorting units of the transport device connected one behind the other in the direction of transport 4.

In the present embodiment a rotatable cylinder 12 with at least one spiral guide track 14 and at least one guide element 16, which can be engaged with the guide track 14, is used to generate the positive fit deflection (i.e. to convert the translatory linear movement in the direction of transport 14 of the transport device into a rotational movement 10 of a grooved cylinder 12). The guide track 14 is a groove in the surface of the cylinder. In a different embodiment it may however be in the form of a guide track projecting from the surface of the cylinder.

To achieve the right/left movement 8 of the belt band 6, the embodiment shown in FIG. 1 has two spirally opposing guide tracks 14a and 14b, which encircle the cylinder 12. In this embodiment they cross at two points, with the crossing points 180° from each other. The cylinder 12 describes a 360° rotation, so that when the guide elements 16 next engage in the guide track 14 of the cylinder 12 the original position is once again reached.

In the embodiment shown in FIGS. 1 and 2, two pin-like guide elements 16a and 16b or 16c and 16d engage by means of activation rollers 34 preferably on bearings with the guide track 14a or 14b, which can be moved after engagement. Engagement of the successive guide elements 16a and 16b or 16c and 16d with the guide track 14a or 14b of the cylinder 12 is shown in FIG. 2. However the engagement of only one (or more than two) guide element(s) is also possible. The successive pin-like guide elements 16a and 16b or 16c and 16d ensure that the cylinder 12 is not without guidance in the area of the crossing points of the guide tracks 14a and 14b. The distance between the guide elements 16a and 16b or 16c and 16d is preferably selected so that the first guide element 16a or 16c has already left the crossing point of the two guide tracks 14a and 14b encircling the cylinder 12, before the second guide element 16b or 16d reaches the crossing point. An insertion aid is provided for reliable and quiet insertion of the guide elements 16a and 16b or 16c and 16d into the guide track 14a or 14b of the cylinder 12.

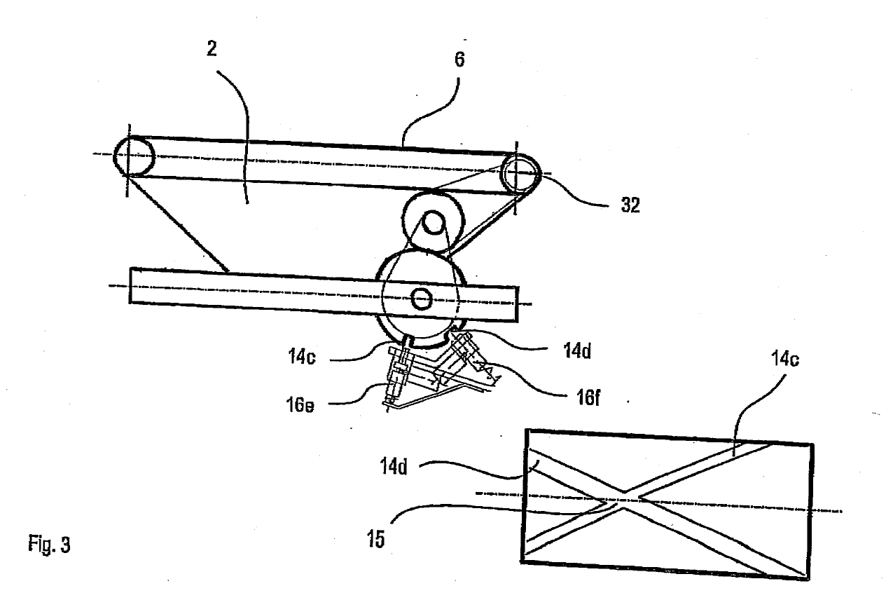

A further structural option to ensure precise guidance of the guide elements at the crossing points of the guide tracks is shown in FIG. 3. It comprises the configuration of guide tracks 14c and 14d with different depths and widths. For example the first guide track 14c can be narrower and deeper and the second guide track 14d wider and less deep compared with the first guide track 14c. Appropriately shaped guide elements 16e, 16f have a structural design appropriate for the guide tracks 14c, 14d in this embodiment. Therefore in this embodiment only one guide element 16e, 16f can be provided for each guide track 14c, 14d and this is configured according to the width and depth of the relevant guide track 14c, 14d.

As shown in FIG. 1, there is in a fixed connection between the cylinder 12 and the sorting unit 2. The cylinder 12 is therefore moved with the sorting unit 2. The guide elements 16a and 16b or 16c and 16d on the other hand are mounted so that they are stationary. The guide elements 16 are mounted on the left and/or right side of the transport device, so that the right/left movement 8 of the belt band 6 is facilitated to either of the two sides.

The cylinder 12 is located in rotatable fashion on a support tube 18, which in turn is connected to the travel gear 20 of the transport device. A belt pulley 22 is mounted permanently on the cylinder 12 and drives a further belt pulley 26, which for its part is mounted permanently on a guide cylinder 32 of the belt band 6, by means of a toothed belt 24. This results in the transfer of the rotational movement of the grooved cylinder 12 to the rotational movement 28 of the belt band guide cylinder 32 and therefore to the movement 8 of the belt band 6.

Depending on the intended direction of rotation 8 of the belt band 6 of the sorting unit 2, the left or right guide elements 16a and 16b or 16c and 16d in the direction of movement of the transport device are engaged on the basis of a control signal. This movement is shown in FIG. 2 by means of arrows 30.

The guide elements 16a and 16b or 16c and 16d in the embodiment shown in FIG. 2 bring about a 360° rotation of the cylinder with continuous linear movement in the direction of transport 4 of the transport device. This rotation is converted on the basis of the displacement into a rotation of the belt band 6 of the sorting unit 2.

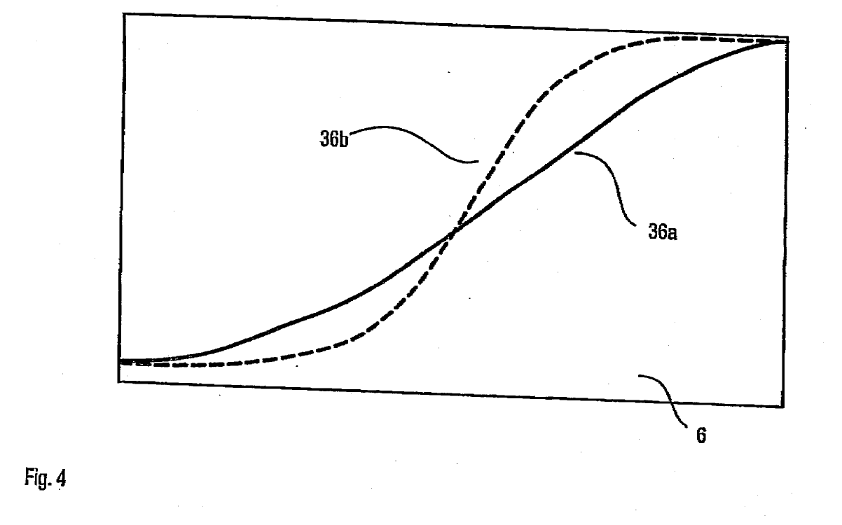

FIG. 4 shows a particularly advantageous embodiment of the guide track 14 of a grooved cylinder for the movement of the belt band 6 of the sorting unit 2 in one direction, such that is has a smaller gradient at its beginning and/or its end than in its central area, so the gradient pattern is continuous. This means that after a 360° rotation and after release of the guide elements 16 the cylinder remains in this position and does not turn back. The subsequent guide elements on one of the following sorting units 2, which engage, can therefore re-engage in the initial position of the guide track 14 of the grooved cylinder 12. As shown in FIG. 4 the curvature of the guide track can be configured flat 36a or at an angle 36b depending on the required movement of the belt band.

To discharge the unit loads into the individual discharge stations, it is necessary for the belt band 6 of the sorting unit 2 to move appropriately with the required belt band advance for the relevant application. For this the diameter of the two belt pulleys 22 and 26 are dimensioned so that the necessary advance of the belt band 6 of the sorting unit 2 is ensured with a rotational movement of the grooved cylinder 12 once about its own axis. This allows precise transfer of the unit loads to the transport device and delivery of the unit loads to the receiving stations.

In an alternative embodiment the axial length of the cylinder 12 can be determined to ensure the belt band advance required for the relevant application from a whole-number multiplication of the guide track 14 360° around the cylinder 12. This means that an increase in the number of guide tracks around the cylinder allows the axial length of the cylinder to be reduced, while still ensuring the same advance of the belt band. This means that the dimensions of the cylinder 12 can be small. It also means that the width of the sorting unit 2 can be reduced.

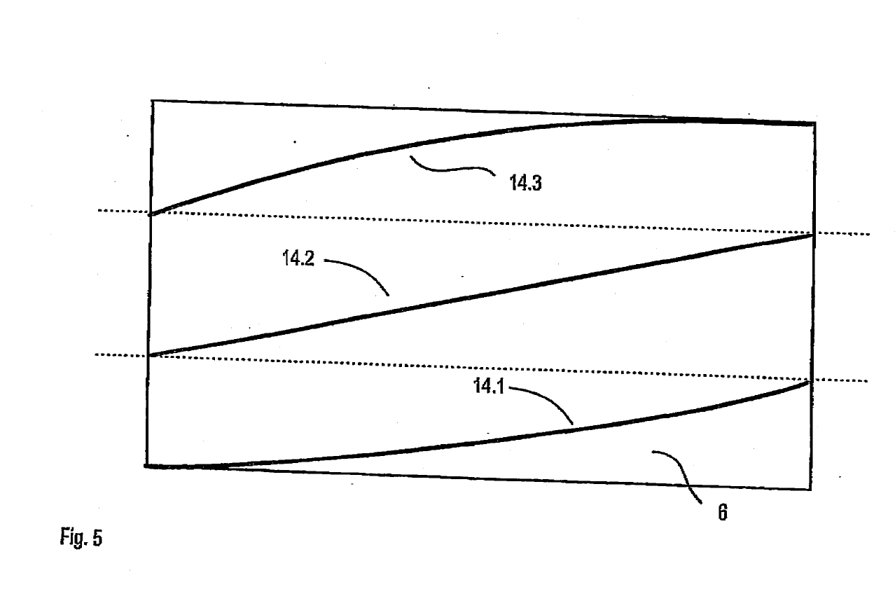

A further alternative embodiment of the guide track of the cylinder is shown in FIG. 5. The guide track 14 here is divided into various guide track segments 14.1, 14.2, 14.3. In this embodiment a number of elements engage and rotate the cylinder gradually. This cylinder rotation can be accelerated, operated at constant speed or slowed down according to the curvature of the guide track segments. The axial length of the cylinder 12 can therefore be reduced and different speed profiles can be produced for the belt band 8 of the sorting unit 2.

The invention being thus described, it will be obvious that the same may be varied in many ways. The variations are not to be regarded as a departure from the spirit and scope of the invention, and all such modifications as would be obvious to one skilled in the art are intended to be included within the scope of the following claims.

We claim:

1. A sorting unit, comprising:
at least one endless belt for conveying an item;
a plurality of rotational drive means operating said at least one endless belt in a first direction; and
means for displacing said unit in a second direction by converting rotational movement of said rotational drive means into a deflection force urging said unit in said second direction.

2. The sorting unit according to claim 1, wherein said first direction is substantially transversal to said second direction.

3. The sorting unit according to claim 1, wherein said rotational drive means comprises a rotatable cylinder mechanically linked to at least one pulley, such that rotational force of said cylinder is imparted upon said pulley, and said pulley directly operates said endless belt in said first direction.

4. The sorting unit according to claim 3, wherein said means for displacing comprises at least one track in said cylinder and at least one guide element for engaging said track, such that said engaging translates rotational movement of said cylinder into transversal movement of said sorting unit substantially in said second direction.

5. The sorting unit according to claim 4, wherein said track forms a spiral shape about said cylinder.

6. The sorting unit according to claim 4, wherein said guide element comprises a head having a shape matching a depth and width of said track.

7. The sorting unit according to claim 6, wherein said head comprises a roller on bearings.

8. The sorting unit according to claim 4, wherein said track comprises at least two spiral guide tracks in different directions crossing at at least two locations.

9. The sorting unit according to claim 8, wherein each of said tracks has a different width and depth.

10. The sorting unit according to claim 3, wherein said cylinder is rotatably mounted on a support tube.

11. The sorting unit according to claim 10, further comprising a travel gear and wherein said support tube is connected to said travel gear.

12. The sorting unit according to claim 3, wherein said at least one pulley comprises a first and a second pulley, said first pulley being mounted on a guide cylinder, and said endless belt running between said two pulleys.

13. The sorting unit according to claim 12, wherein a diameter of said first pulley is dependent upon a diameter of said second pulley, diameter of said cylinder, and length of said belt.

14. The sorting unit according to claim 13, wherein said diameter of said first and said second pulleys are dimensioned such that rotational movement of said cylinder about its axis imparts a select advancement of said belt in said first direction.

15. The sorting unit according to claim 4, further comprising an insertion aid for at least one of said at least one guide elements, said aid provided at a start of said track.

16. The sorting unit according to claim 4, wherein said at least one guide element is fixed with respect to said second direction and can be made to selectively engage and selectively disengage said track in response to a control signal.

17. The sorting unit according to claim 16, wherein a position of said at least one guide element with respect to said cylinder may be selected dependent upon said first direction or said second direction.

18. The sorting unit according to claim 4, wherein said track has a smaller gradient at a beginning track location than at a non-beginning track location.

19. The sorting unit according to claim 4, wherein an axial length of said cylinder is substantially equal to a whole number multiplication of a length of said track around said cylinder.

20. The sorting unit according to claim 19, wherein said length runs approximately 360° around said cylinder.

21. An item distribution line including at least one sorting unit each comprising:
at least one endless belt for conveying an item;
a plurality of rotational drive means operating said at least one endless belt in a first direction; and
means for displacing said unit in a second direction by converting rotational movement of said rotational drive means into a deflection force urging said unit in said second direction.

22. A method for conveying an item on a sorting unit, comprising the steps of:
engaging at least one track in said cylinder with at least one fixed guide element, said cylinder in driving association with an endless belt; and
selectively rotating said cylinder such that said belt moves in a first direction and said sorting unit moves in a second direction, such that an item on said belt is selectively displaced in said first direction while said sorting unit is selectively displaced in said second direction.

23. The method according to claim 22, wherein said first direction is substantially transversal to said second direction.

24. The method according to claim 22, wherein said track forms a spiral shape about said cylinder.

25. The method according to claim 22, wherein said element comprises a head having a shape matching a depth and width of said track.
